(19) United States
(12) Patent Application Publication
(10) Pub. No.: US 2025/0095034 A1
(43) Pub. Date: Mar. 20, 2025

(54) CONSULTANCY ASSISTANCE AND CORRELATION SYSTEMS AND METHODS

(71) Applicant: Diligence Fund Distributors Inc., Houston, TX (US)

(72) Inventors: Kevin D. HOWARD, Mesa, AZ (US); Devon DREW, Houston, TX (US)

(21) Appl. No.: 18/370,266

(22) Filed: Sep. 19, 2023

(51) Int. Cl. G06Q 30/02

(52) U.S. Cl. CPC G06Q 30/0281

(57) ABSTRACT

Computer systems and software methods can be configured to automatically correlate novice actor preferences of subject matter items (e.g., goods and services) and provider data across multiple platforms, guided by item displayers. The displayers can use novice actor preferences, available items with third-party evaluations, and generative Artificial Intelligence (AI) to guide toward stated goals. The system can automatically generate a list of items, associated with displayer-provided workflow steps, to be matched with preferences. These items can be listed in order based on the AI-determined probability of each meeting novice actor goals. Providers who interact with the system operator can ensure that their goods and services are included within the system.

### FIELD

This disclosure generally relates to software systems and methods and, more particularly, to software systems and methods to automatically correlate subject matter items and provider data across multiple platforms.

### BACKGROUND

Since 1959, when IBM's Arthur Samuel pioneered machine learning (ML), it has been used to perform data matching. The concept of information extraction became widespread in 1987 by the US Navy's MUC-1 Naval operations message system, with significant support by the US Defense Advanced Research Projects Agency throughout the 1990s. The proliferation of the World Wide Web after its introduction in 1990 by Tim Berners turned the internet into a series of interlocked documents, making it accessible to computer-based information extraction. There have been many tools created to extract text-based information: naïve Bayes classifiers, support vector machines, multinomial logistic regression, recurrent neural networks, and maximum-entropy Markov models, to name a few. These conventional extraction techniques use a regression analysis and/or low-dimensional classification schemes. Although these models have had success with smaller datasets, they require supervised training of the dataset. The amount of data needed to train a system to represent accurate natural language processing is very large and, thus, the amount of training time required makes the effort very costly.

In 2018, Jacob Devlin created a new technique called the Bidirectional Encoder Representations from Transformers (BERT) model. BERT and its successors, Generative Pre-trained Transformer (GPT2, GPT3, GPT4), Transformer XL (XLNet), Robustly Optimized BERT (ROBERTa), etc., use high-dimensional classification schemes like embedded transformers.

Training for BERT and its successors is unsupervised and highly parallelizable, greatly reducing the training time. With training time no longer acting as the gating item, advanced linguistic techniques, like masked language models and next sentence prediction, can be used to increase the accuracy of extracted meaning and include such concepts as automatic keyword extraction, statement focus and meaning determination, and the writer's sentiment. The writer's sentiment can be given as strongly negative, negative, neutral, positive, and strongly positive for each keyword and statement derived from a given corpus of text.

Social media and search engines allow individuals to search for knowledge and interact globally with others, making it possible to perform online consulting, which from 2015 through 2020 generated $383 billion in value. In the modern world, with the vast amount of information available from multiple sources combined with the effect of influencers on popular opinion, it is very difficult for consultants to track the expanding data available across platforms as well as the frequently changing preferences of clients.

As such, improvements and innovations are needed for an online automated consultancy assistance system, using data scraping technology combined with modern natural language processing techniques.

### SUMMARY OF THE INVENTION

The present invention provides embodiments configured to automatically correlate novice actor preferences of subject matter items (SMIs) in particular subject matter areas (SMAs) and SMI providers as guided by displayers of such items. The SMI displayers use these novice actor preferences, available SMIs with third-party evaluations of those items, and artificial intelligence (AI) to guide novice actors to their stated goals.

In various embodiments, a Subject Matter Item Assistance System (SMIAS) and methods co-joins providers of SMIs and displayers of SMIs that provide access to certain information, goods, or services that are within an SMA. The technology herein uses AI to maximize the success of reaching the goals of a novice actor (system user). The natural language processing (NLP) AI of the system is used to access information about displayer-determined specific SMIs and analyze the sentiment of various third-party evaluators about each SMI in order to rate each item. The context of the NLP AI search for relevant SMIs is formed from the predefined goals of the system user and the current workflow step provided by the SMI displayer. The generative AI of the system is used to determine the probability of any rated SMI in meeting the goals of a system user, then an option list is automatically generated of the rated SMIs with the highest probabilities, in order from highest to lowest. Past user selections and preferences are also used by the generative AI to ensure that the most relevant SMIs are included for a particular system user. The SMIAS also retains its efficacy by using NLP AI to determine which, if any, newly available SMIs can be added to the SMI displayer's available options to determine the relevancy for users. Via the SMIAS controlled by the system operator, anonymous aggregate information can be shared with SMI providers. An SMI user's subject matter expertise can be anonymously determined, tracked, and compared to sentiment from expert analysis and anonymous aggregate SMI user preferences and selections over time.

In various embodiments, an SMIAS as a Consultancy Assistance System (CAS) and method co-joins providers of SMIs and consultants as displayers of SMIs that provide access to certain information, goods, or services that are within a SMA. The NLP AI of the system is used to access information about consultant-determined specific SMIs and analyze the sentiment of various third-party evaluators about each SMI in order to rate each item. The context of the NLP AI search for relevant SMIs is formed from the predefined goals of the client (system user) and the current workflow step provided by the consultant. The generative AI of the system is used to determine the probability of any rated SMI in meeting the goals of a client, then an option list is automatically generated of the rated SMIs with the highest probabilities, in order from highest to lowest. Past client selections and preferences are also used by the generative AI of the system to ensure that the most relevant SMIs are included for a particular client. The SMIAS also retains its efficacy by using NLP AI to determine which, if any, newly available SMIs can be added to the consultant's available options to determine the relevancy for clients. Via the SMIAS controlled by the system operator, anonymous aggregate information can be shared with SMI providers. A client's subject matter expertise can be anonymously determined, tracked, and compared to sentiment from expert analysis and anonymous aggregate client preferences and selections over time.

Consulting services provide expertise and advice specific to a client's goals and preferences for consideration. This invention presents systems and methods as tools for a consultancy organization and can benefit the consultant, the client, and SMI providers. The system of the present invention automatically generates a targeted list of relevant SMIs, associated with consultant-provided workflow steps, to be matched with client preferences for use in meeting client goals. All SMI providers are analyzed for the value of their offered items and reputation, based on online expert analyses, third-party reviews, newsfeeds, and social media posts. SMI providers who interact with the system operator can ensure that their goods and services are legitimately included within the system, and the system operator can provide anonymous aggregate client preferences and selections to the SMI provider as a service.

Since the meaning, focus, and sentiment can be directly obtained from text data (and even image data), the present invention can automatically correlate specific SMIs and provider data gleaned from webpages across multiple platforms. In an online consultancy setting, the client is appropriately presented with a list of acceptable items with associated providers within that subject matter from which they can select an option. Unlike standard online searches which have no context and thus depend only on the efficacy of a given set of queries, SMI searches using the present invention derive context from the workflow of the consultant, which provides boundaries for the results. Subject matter results of that search are associated with the context and sorted based on the current preferences of the client and the probability of reaching their goals as determined by the generative AI of the system.

Client preferences can encompass not only the traditional goods and services (SMIs) but also the perceived value of the items from third-party evaluators (expert analysis, third-party reviews, newsfeeds, social media posts, etc.), any item-associated provider corporate reputation and corporate leadership behavior, and such diverse concepts as a place of origin for goods or services, past-present-future business ties, and the provider's service or philanthropic philosophy.

By using data gathering bots and modern natural language processing to automatically capture both client preferences and platform-independent SMIs with associated providers, the present invention can better match relevant SMIs found by online consulting services with the needs of their clients. The CAS of the present invention has three categories of users: system operators, consultants, and clients.

A system operator provides a set of keywords and seed URLs to the CAS on a per subject matter basis. Subject matter is defined herein as the area of expertise related to a class of consultants. For example, a furnishing consultant's subject matter might contain information on various kinds of furniture and home and office accessories with associated vendors and manufacturers. The CAS finds the relevant SMIs and their associated providers, while generating and attaching semantic embedding to match those items to the preferences of the consultant's clients.

Consultants construct workflows to ensure that the options presented to clients are ones that can be offered by the consultant and all required work for a client is completed in the necessary order. A workflow consists of a number of workflow steps, each containing a list of subject matter keywords which are a subset of the keywords used by the system operator to locate SMIs for the purpose of matching to client preferences. For example, for a financial consultant, workflow steps could include gathering information on investments, qualifying a client for a set of funds, determining investment types, and qualifying particular potential investments. Each consultancy has its own workflow, even those using the same subject matter. The workflow steps help define the context needed for matching items to client preferences.

Clients go to consultants for expertise on a subject matter. They expect to be presented with choices that they find acceptable and help them achieve some set of goals. To define acceptable, the client usually creates a profile that is used by the system as the starting point for their preferences. The CAS accesses the client preferences and provides semantic embedding so that SMIs can be matched to the preferences of the consultant's clients in the context of the consultant's workflow steps. Changes in the SMA or in the client's preferences require different options to be presented; the present invention automatically and continuously tracks both.

The above and other aspects of the embodiments described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and enable a person skilled in the pertinent art to make and use the embodiments disclosed herein. In the drawings, like reference numbers indicate identical or functionally similar elements.

FIG. 1 shows a block diagram of a Subject Matter Item Assistance System (SMIAS) and method that co-joins providers of SMIs and displayers of SMIs, which can provide access to certain information, goods, or services that are within an SMA, in accordance with embodiments of the present invention.

FIG. 2 shows a block diagram of an SMIAS as a Consultancy Assistance System (CAS) and method that co-joins providers of SMIs and consultants as displayers of SMIs, which can provide access to certain information, goods, or services that are within a SMA, in accordance with embodiments of the present invention.

FIG. 3 shows a diagram of an example of a CAS that enhances consultant, client, and SMI provider systems using natural language processing on internet webpage text to obtain SMIs, expert analyses, third-party reviews, newsfeeds, and social media posts, to determine the sentiment of what is extracted, and match preferences to SMIs to generate options, in accordance with embodiments of the

FIG. 4 shows an example diagram of a system operator providing an initial set of keywords and URLs to a data-gathering bot, which searches webpages and all related links, including those from third-party evaluators and regardless of the platform generating the text, to build a set of SMIs, in accordance with embodiments of the present invention.

FIG. 5 shows a diagram of an example consultant workflow with multiple workflow steps, each containing options to be presented to the client, in accordance with embodiments of the present invention.

FIG. 6 shows an example diagram of a simplified model for multi-platform-based goods or services selection for presentation to a client, in accordance with embodiments of the present invention.

FIG. 7 shows an example diagram of a plan from a consultant to a client with option items at each plan step provided by the CAS to the consultant, in accordance with embodiments of the present invention.

FIG. 8 shows an example diagram of a consultant's written advice to a client with associated CAS-provided options, in accordance with embodiments of the present invention.

FIG. 9 shows an example diagram of a simplified system operator and SMI provider interaction, in accordance with embodiments of the present invention.

FIG. 10 shows a flow diagram for a consultancy assistance system, in accordance with embodiments of the present invention.

### DETAILED DESCRIPTION OF PREFERRED EMBODIMENTS

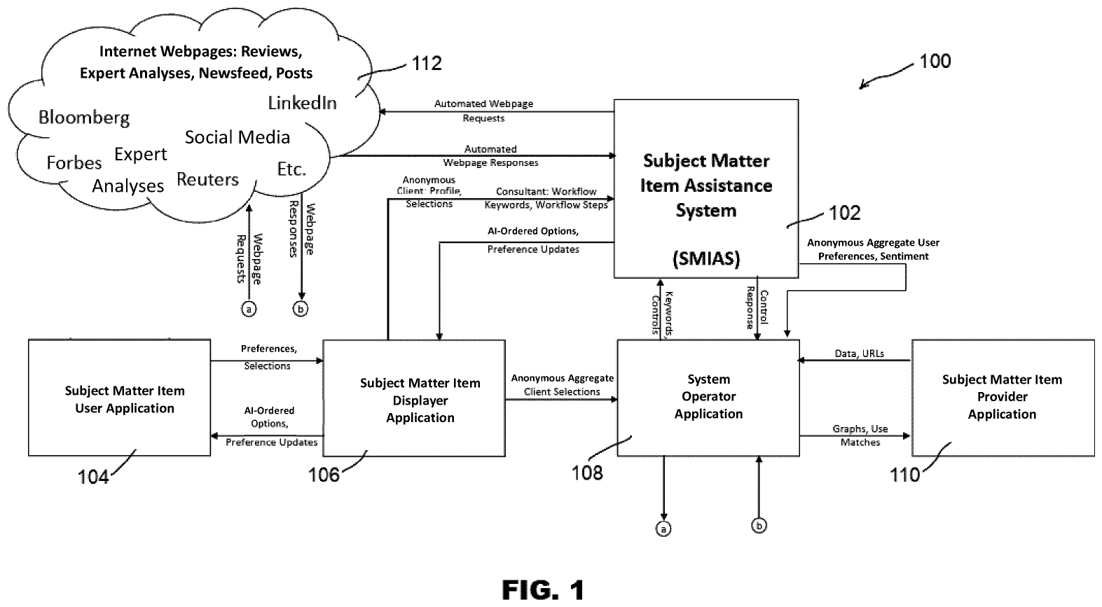

Referring generally to FIGS. 1-10, the present invention comprises software systems and methods as tools for subject matter item (SMI) displayers or consultants that can benefit the SMI displayers or consultants, SMI users or clients, and SMI providers. The NLP AI of the system is used to access information about displayer- or consultant-determined specific SMIs and analyze the sentiment of various third-party evaluators (expert analyses, third-party reviews, newsfeeds, social media posts, etc.) about each SMI in order to rate each item. The context of the NLP AI search for relevant SMIs is formed from the predefined goals of the system user or client and the current workflow step provided by the SMI displayer or consultant. The generative AI of the system is used to determine the probability of any rated SMI in meeting the goals of a system user or client, then an option list is automatically generated of the rated SMIs with the highest probabilities, in order from highest to lowest. Past user selections and preferences are also used by the generative AI to ensure that the most relevant SMIs are included for a particular system user or client. The system also retains its efficacy by using NLP AI to determine which, if any, newly available SMIs can be added to the SMI displayer or consultant's available options to determine the relevancy for users or clients. Via the system controlled by the system operator, anonymous aggregate information can be shared with SMI providers. An SMI user or client's subject matter expertise can be anonymously determined, tracked, and compared to sentiment from expert analysis and anonymous aggregate SMI user or client preferences and selections over time. SMI providers who interact with the system operator can ensure that their goods and services are included within the system and can receive anonymous aggregate user or client preferences and selections as a service from the system operator.

FIG. 1 shows a diagram of a Subject Matter Item Assistance System (SMIAS) 100 and methods that co-joins providers of SMIs and displayers of SMIs that provide access to certain information, goods, or services that are within a SMA. The system 100 can include a gathering, storage and processing SMIAS system 102, one or more SMI users 104, one or more SMI displayers 106, and one or more system operators 108, all in operative processing communication. A SMI provider 110 is in operative communication with the system operator 108. The system 102 automatically correlates specific SMIs and provider data from webpages across multiple platforms 112 (e.g., expert analyses, third-party review, newsfeeds, social media posts, etc.) with an SMI user's 104 preference data compiled from all relevant data accessed by SMI users 104 after their identifying information has been removed, including names, geographic locations, MAC addresses, etc.

Novice actors, such as the SMI users 104, are able to describe or provide their preferences to the SMI displayers 106, who use the SMIAS 102 to automatically sift, using SMI displayer-provided workflows, through the internet, or other network environments, to find information from expert analysis, third-party reviews, newsfeeds, and social media posts about certain SMIs. Using AI, the sentiment of that written information is determined 102. Current internet-obtained information sentiment and individual SMI user preferences inform the options offered by the SMI displayer 106 to the SMI user 104 to help them make selections to reach their stated goals. Via the SMIAS controlled by the system operator 108, anonymous aggregate information can be shared with SMI providers 110. An SMI user's 104 subject matter expertise can be anonymously determined, tracked, and compared to the sentiment from expert analysis and anonymous aggregate SMI user preferences and selections over time.

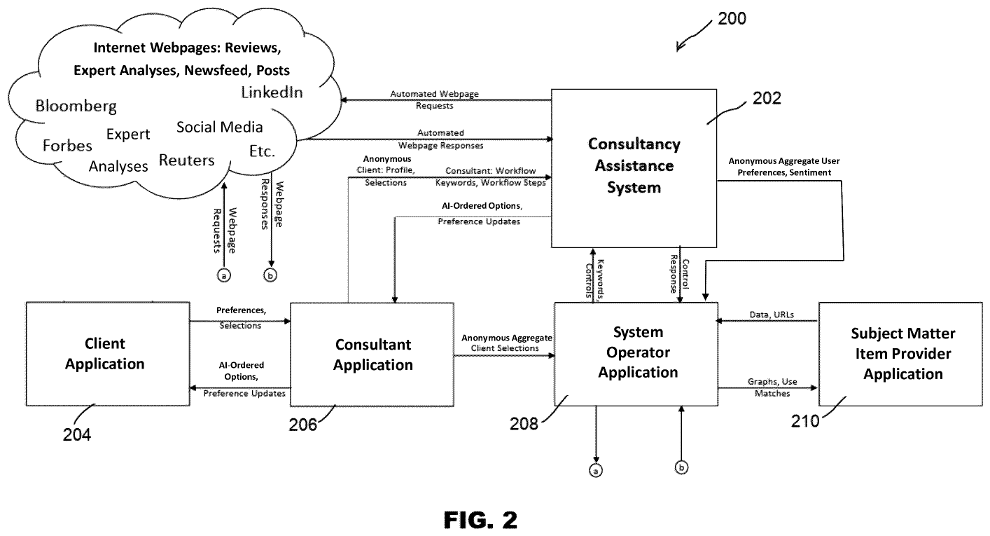

FIG. 2 shows a diagram of an SMIAS as a Consultancy Assistance System (CAS) 200 and method that co-joins providers 210 of SMIs and consultants as displayers of SMIs, which can provide access to certain information, goods, or services that are within a SMA. The system 200 can include a gathering, storage and processing CAS system 202, one or more clients 204, one or more consultants 206, and one or more system operators 208, all in operative processing communication. Clients 204 are able to describe or provide their preferences to consultants 206 who use the CAS 202 to automatically sift, using consultant-provided workflows, through the internet, or other network environments, to find information from expert analyses, third-party reviews, newsfeeds, and social media posts about certain SMIs. Using AI, the sentiment of that written information is determined at CAS 202. Current internet-obtained information sentiment and individual client preferences inform the options offered by the consultant 206 to the client 204 to help them make selections to reach their stated goals. Via the CAS controlled by the system operator 208, anonymous aggregate information can be shared with SMI providers 210. A client's 204 subject matter expertise can be anonymously determined, tracked, and compared to the sentiment from expert analysis and anonymous aggregate client preferences and selections over time.

The following list details various features, processing methods and steps, and system aspects in accordance with embodiments of the present invention.

### Subject Matter Items

1) SMIs, originating from SMI providers, include online goods, services, and content with text or image-based descriptions and the sentiment from relevant expert online analyses, third-party reviews, newsfeeds, and social media posts are saved in the system database for use by online consultants. SMIs are presented by a particular consultant to their clients.
2) The system employs a webpage text-extraction tool (a set of web page accessing bots) and natural language processing (using BERT, GPT-GPT4, or other NLP AI engines), informed by consultant-provided workflows, to automatically generate a list of ordered options based on generative AI-determined probability of meeting client goals, to present to the client.

### Client Subject Matter Expertise and Preferences

1) Client profile, including preferences, is provided to the consultant.
2) The system uses the client selections to update their preferences, an AI trained by client selections continuously stores, processes, and updates the preferences of the client.
3) The system compares the sentiment from client preferences and selections to sentiment from expert analysis and anonymous aggregate client data to determine the client expertise. The closer client choices match the aggregate expert choices the more expert they are deemed.

### Client Subject Matter Item Selection

1) A consultant's workflow consists of a set of work plans and a set of related decision points that are generative AI-derived and require a client to make an SMI selection, triggering a decision at a specific decision point in the workflow.
2) The client's ordered selection options are placed into the client plan at a particular workflow step, based on the client's preferences and all data related to the SMIs as analyzed by the system's NLP AI.

### Consultant Subject Matter Item Selection Prediction and Trends

1) The system also uses the webpage text-extraction tool and natural language processing, informed by consultant-provided workflows, to automatically determine the sentiment of all SMIs and relevant data over time in order to predict trend lines and possible future selections for inclusion in or removal from future workflows.
2) The sentiment determined by the aforementioned tools can include strongly negative, negative, neutral, positive, or strongly positive.

### System Operator Interactions

1) The system operator uses a seed website page list (URLs) and keywords to find relevant webpages for a SMA, from which text is extracted and natural language processing applied to find the SMIs used within a SMA.
2) Links on the various website pages are automatically followed and their text is automatically analyzed to fully scope the SMA.
3) Providers of the detected SMIs are themselves automatically found and associated with the SMIs, along with the SMI provider-specific data, like price, availability, discounts, etc.
4) Third-party evaluators (expert analysis, third-party reviews, newsfeeds, social media posts, etc.) for the SMA are found and their sentiments are determined using the natural language processor analysis of the text-extracted SMA webpages.

### Subject Matter Item Provider Interactions

1) The relevant anonymous aggregate consultant SMI presentations to clients and the anonymous aggregate SMI selections by clients are shown to the SMI provider.
2) The characteristics (like price, availability, discounts, etc.) of the SMIs that are selected are shown.
3) For multiple providers of SMIs the percentage of that item's selection by clients per provider is shown.

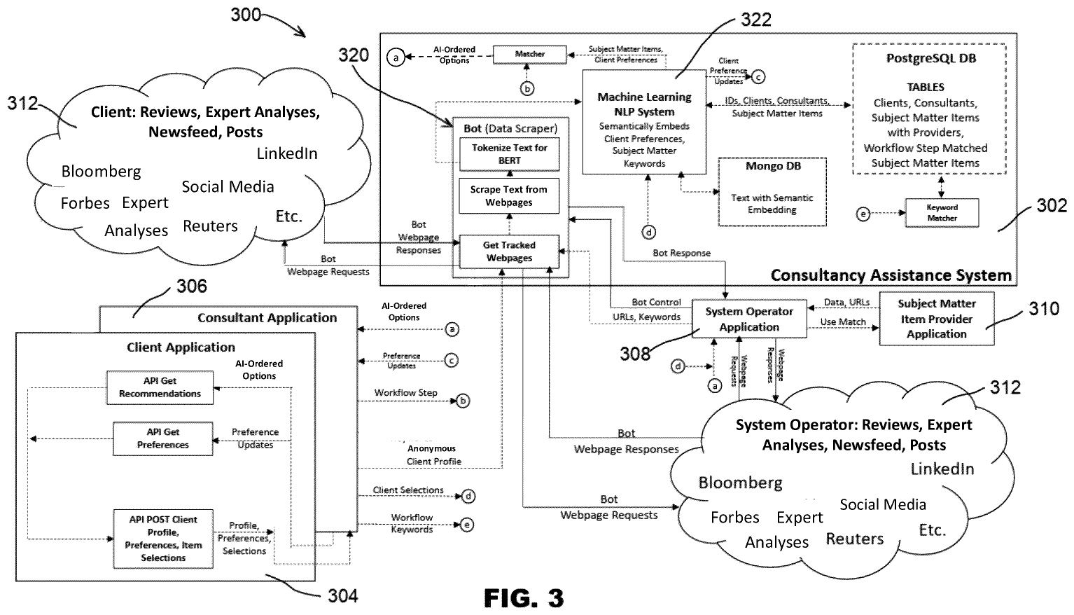

Referring generally to FIGS. 3-9, a diagram of an SMIAS 300 is configured to support online consultants. The Consultancy Assistance System (CAS) 302 is shown that automatically captures SMI data and subject matter provider data across platforms 312 using system operator-provided 308 keywords and URLs using a bot 320 then annotates that data using semantic (e.g., meaning and interpretation) analysis 322. The system 300 can include the CAS 302, one or more clients 304, one or more consultants 306, one or more system operators 308, and one or more SMI providers 310, all in operative processing communication.

The system 300 automatically updates the preferences of consulting-service clients 304 for specific SMIs by using semantic analysis 322 of the online platform-independent text associated with the SMIs selected by each client 304 along with their initial profile. The system 300 automatically matches relevant internet-obtained, platform-independent, annotated subject matter data that has been selected by the consultant 306 via provided workflow steps with generated and managed client preferences. The system operator 308 can interact with SMI providers 310 for inclusion in the set of system-known SMIs and providers. Client 304 and consultant 306 preference data, as well as data for providers 310 that interact with the system operator 308, are automatically updated.

The circled alphabetic references (e.g., a, b, c, d . . . n) in FIG. 3 are line connectors, referencing data inputs and/or outputs within the figure.

The present invention comprises software systems and methods 300 as tools for consultancy organizations that can benefit the consultant 306, the client 304, and SMI providers 310. This system uses NLP and generative AI in multiple ways: sentiment analysis of online third-party evaluators (expert analyses, third-party reviews, newsfeeds, social media posts, etc.), automatic client and consultant preference updates, generation of SMI option lists based on probability of meeting client goals, automatic plan provisioning based on the current plan in the current workflow step, and the automatic determination of new SMIs for display. The CAS 302 of the present invention automatically generates a client-targeted list of relevant SMIs, associated with consultant-provided plans within their workflow steps, to be matched with continuously updated client preferences, generating a list of probability-ordered options to be presented to the client 304. SMIs can be listed in order based on third-party evaluators (expert analyses, third-party reviews, newsfeeds, social media posts, etc.), if any, and the best fit for client preferences, with or without associated providers 310. All providers 310 are analyzed for the value of their offered items and reputation, based on online third-party evaluators. SMI providers 310 who interact with the system operator 308 can ensure that their goods and services are included within the system and can receive anonymous aggregated client data.

Client preferences can encompass not only traditional goods and services (SMIs) but also the perceived value of the items from third-party evaluators, any item-associated provider corporate and corporate leadership behavior identified in third-party evaluators, and such diverse concepts as a place of origin for goods or services, past-present-future business ties, and the provider's service or philanthropic philosophy.

By using data-gathering bots or a bot engine 320 and modern natural language processing or an NPL engine 322 to automatically capture both client preferences and platform-independent SMIs with associated providers 310, the present invention can better match relevant SMIs found by online consulting services with the needs of their clients 304.

The system operator 308 provides a set of keywords and seed URLs to the CAS 302 on a per subject matter basis. Subject matter is defined herein as the area of expertise related to a class of consultants 306, identified as SMI displayers in an SMIAS not configured to support consultants. For example, a furnishing consultant's subject matter might contain information on various kinds of furniture and home and office accessories with associated vendors and manufacturers. The CAS 302 finds relevant SMIs and their associated providers 310, while generating and attaching semantic embedding 322, to match those items to the preferences of the consultant's clients 304.

Consultants 306 construct workflows to ensure that the options presented to clients 304 are ones that can be offered by the consultant 306 and all required work for a client 304 is completed in the necessary order. A workflow consists of a number of workflow steps, each containing a list of subject matter keywords which are a subset of the keywords used by the system operator 308 to locate SMIs for the purpose of matching to client preferences. For example, for a financial consultant, workflow steps could include gathering information on investments, qualifying a client for a set of funds, determining investment types, and qualifying particular potential investments. Each consultancy has its own workflow, even those using the same subject matter. The workflow steps help define the context needed for matching items to client preferences.

To define what is acceptable, the client 304 can create a profile that is used by the system 302 as the starting point for their preferences. The CAS 302 accesses the client preferences and provides semantic embedding 322 so that SMIs can be matched to the preferences of the consultant's clients 304 in the context of the consultant's workflow steps. Changes in the SMA or in the client's preferences require different options to be presented; the present invention automatically and continuously tracks both.

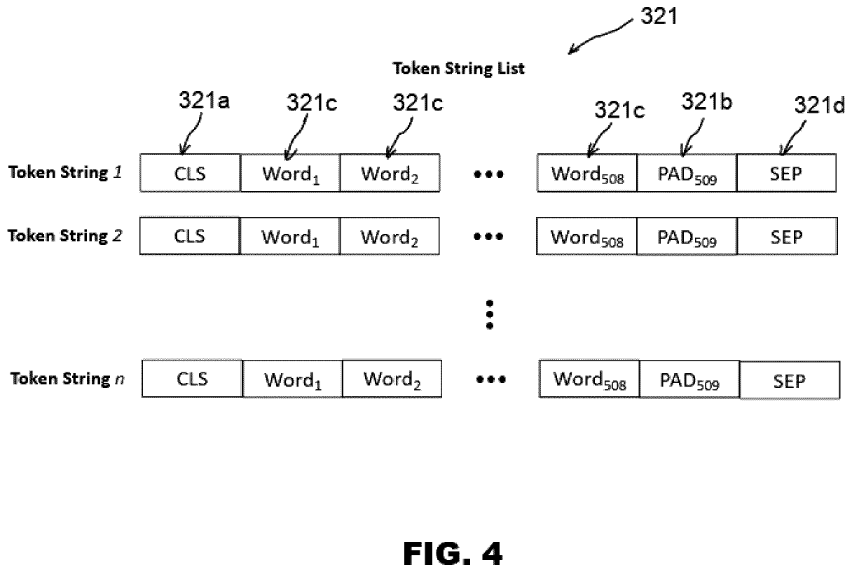

Referring to FIG. 4, the system operator 308 provides an initial set of keywords and URLs to the data-gathering bot 320, which searches webpages and all related links, including those from third-party evaluators (expert analyses, third-party reviews, newsfeeds, social media posts, etc.) and regardless of the platform generating the text, to build a set of SMIs. The text from each found webpage is extracted, and tokens 321 are added and text formatted as required by the natural language processor (NLP) 322. Using the NLP subsystem 322, the text is analyzed, resulting in the extraction of focus, meaning, and sentiment about the keywords and key phrases. SMIs with associated providers and review data from third-party evaluators for both the items and the providers are then identified, using the focus, meaning and sentiment values, and then saved.

Embodiments of the present invention can include a preferred method of natural language processing 322 using the Bidirectional Encoder Representations from Transformers (BERT) model. This model has been trained with a large English language database and comes complete with masked language models (MLM) and next sentence prediction (NSP). All that is required is training for specialty words and phrases, after which the system 302 is ready to accept text for analysis. A “BertTokenizer” is the tool used by the data-gathering bot 320 when the BERT model is used. It takes text strings from webpages, texts, queries, posts, etc., and converts those text strings into a list of tokens 321. As shown in FIG. 4, there are only four types of tokens 321 required by the BERT model in certain embodiments: a category token (CLS) 321a, an unused token area designator (PAD) 321b, words 321c, and a sequencing token (SEP) 321d. Within the BERT model, the KeyBERT phrase extraction tool is used to extract key phrases and words from the token lists and attach to the keywords or key phrases information such as parts of speech, word or phrase position, phrase focus and keyword meaning, and sentiment values, such as negative, neutral, or positive.

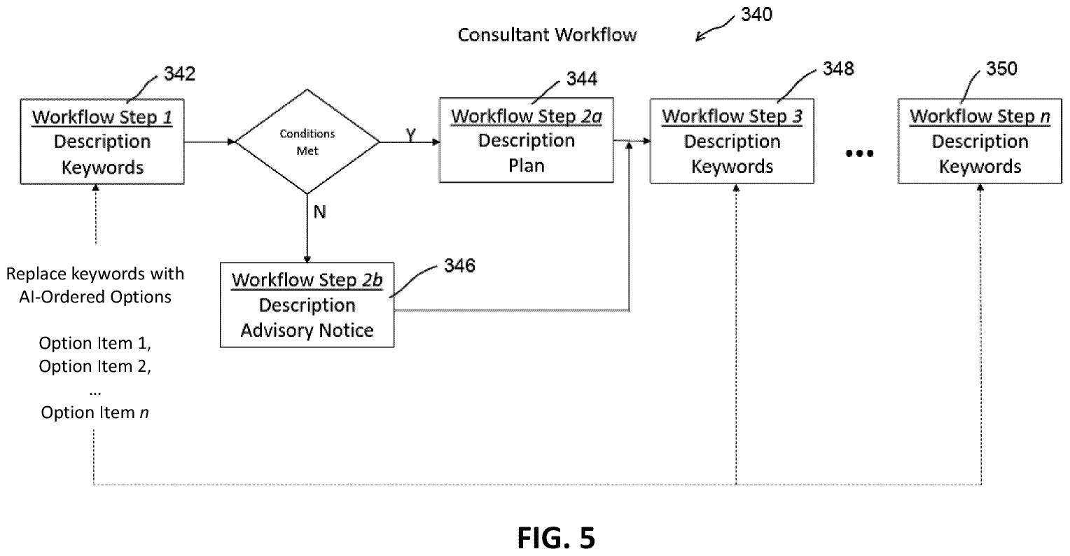

FIG. 5 shows a diagram of an example of a consultant-constructed workflow 340. A workflow can be constructed using drag-and-drop technology similar to that used by the popular no-code/low-code programming model. Example workflow steps can include: providing descriptions and keywords 342, providing descriptions and plans 344, and/or providing descriptions and advisor notices 346. A browser-based work area is accessed by the consultant 306, who adds the workflow steps, each of which contains a description of the activity required by the step and a list of keywords to be used by the system to find keyword matches previously used to find all SMIs that have been saved. Matched SMIs are then stored with the appropriate workflow step and called option items.

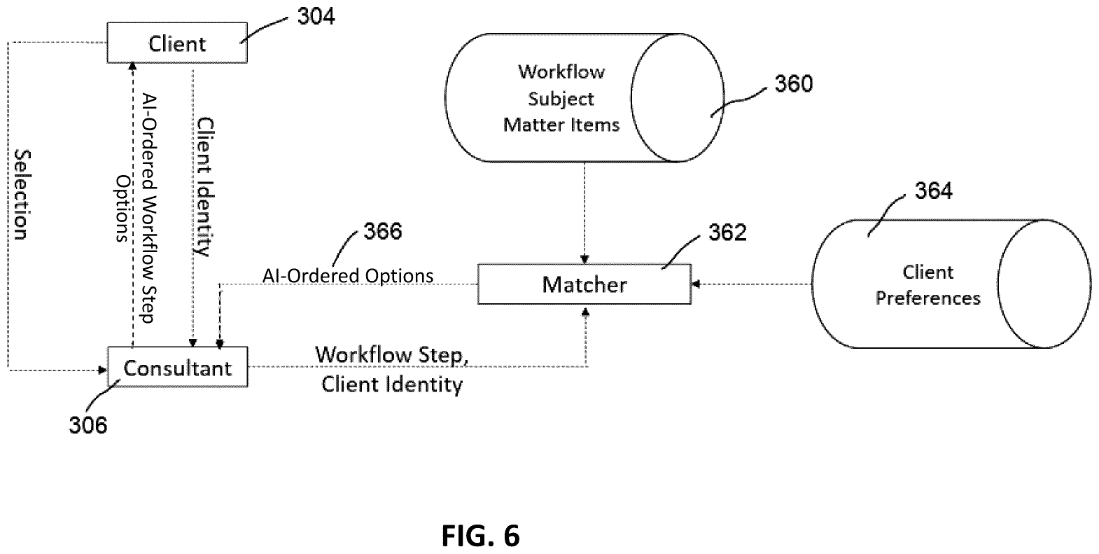

FIG. 6 shows the SMIs and their associated provider information that have been matched to keywords for the current workflow step and stored 360. These SMIs that have been matched to workflow step keywords are compared and matched via a matcher 362 to the client's profile and current preferences 364. The resulting most relevant SMIs, ordered from the highest AI-generated probability of meeting client goals, are then presented as options 366 to the consultant 306 who presents them to the client 304. A recommended item is selected by the client 304 and then used by the consultant 306 to make progress on achieving the client goals.

A client's 304 subject matter expertise can be determined, tracked, and compared to the sentiment from expert analysis and anonymous aggregate client preferences and selections over time. In the process of automatically tracking a client's preferences and selections, the system 302 also automatically computes the percentage match between a client's sentiment and the overall sentiment from analysis by experts in the SMA 312. The closer the client's preferences and selections match expert sentiment, the more their future choices will match expert choices. This concept allows the consultant 306 to coach the client in making better future choices.

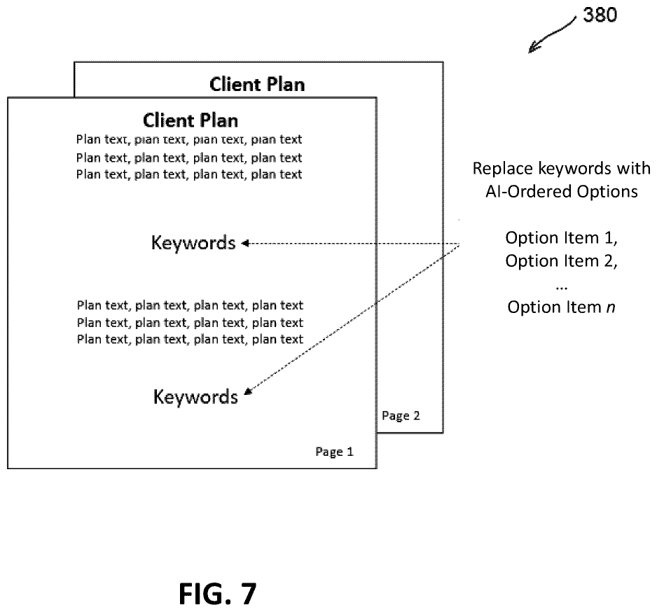

Referring to FIG. 7, planners are online consultants 306 who are typically certified and work with the client 304 to create an action plan for an area of interest at the planning feature 380 of the workflow. The creation of a plan for a client 304 is similar to the creation of a workflow. Like the workflow, a plan has a number of steps, each with SMI options available to the client 304 for selection. As shown in FIG. 5, a plan is part of the planner's workflow, and there can be a plan at each workflow step. Unlike the workflow, the finished plan, after an option item has been selected per step, is a product for the client. FIG. 7 shows that the CAS 302 supports the planner by automatically generating a targeted list of relevant SMIs (options) with associated providers to be matched with a specific client's updated preferences, generating an AI-ordered list of options for each plan step. Note that the order of each option at each step in a client plan is determined by the AI-generated probability that it will help meet the goals of the client.

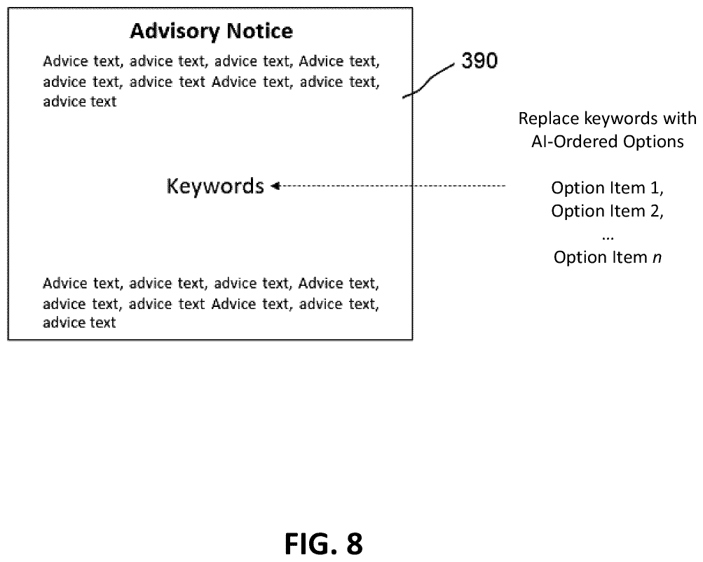

Referring to FIG. 8, advisors are online consultants 306 who are typically registered, especially legal, financial, or medical advisors, and offer purchase or item use advice in the form of an advisory notice 390. The creation of an advisory notice in the advisory notice feature 390 of the workflow for a client 304 is similar to the creation of a workflow. Like the workflow, a notice has a number of steps, each with SMI options available to the client for selection. As shown in FIG. 5, an advisory notice, like a plan, is part of the advisor's workflow, and there can be a notice at each workflow step. Unlike the workflow, the finished advisory notice, after an option item has been selected per step, is a product for the client 304. The CAS 302 supports the advisor 306 by automatically generating an AI-ordered list of relevant SMIs (options) with associated providers to be matched with the aggregate client updated preferences, generating a list of options for each advisory notice step. Unlike a plan, an advisory notice is presented to multiple clients.

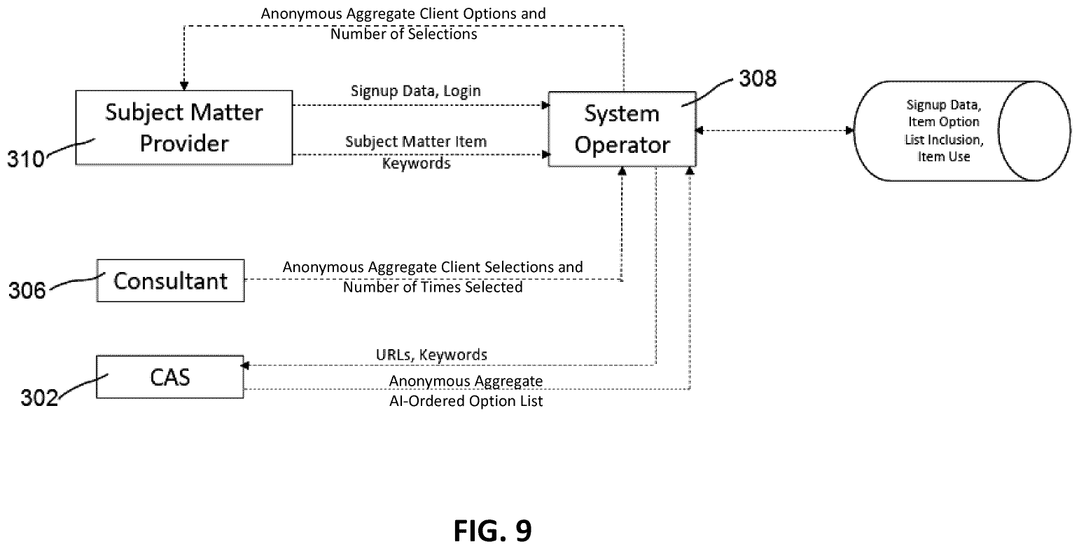

FIG. 9 shows that SMI providers 310 can sign up for inclusion in the CAS 302 by providing information concerning their organization, the SMIs (goods and services) they provide, and the URL of relevant webpages, including for third-party evaluations of both the organization and/or any provided SMI to the system operator 308. The system operator 308 includes this provider info in the keywords and list of URLs that are transmitted to the CAS bot. If there are one or more matches of the provider's SMIs to the preferences of consulting organizations via their workflows, the provider 310 is accepted by the system operator 308. Anonymous aggregate information concerning the inclusion of the provider's SMIs in a list of options to be presented to clients 304 of a consultant 306 and any selection by those clients of a SMI of the provider is transmitted to the provider by the system operator 308. The system 302 periodically scrapes new information from the internet concerning the provider 310 and their offered SMIs to automatically update their information. The system operator 308 periodically requests from the CAS 302 a new internet search to find new SMI providers 310 who can be invited to sign up.

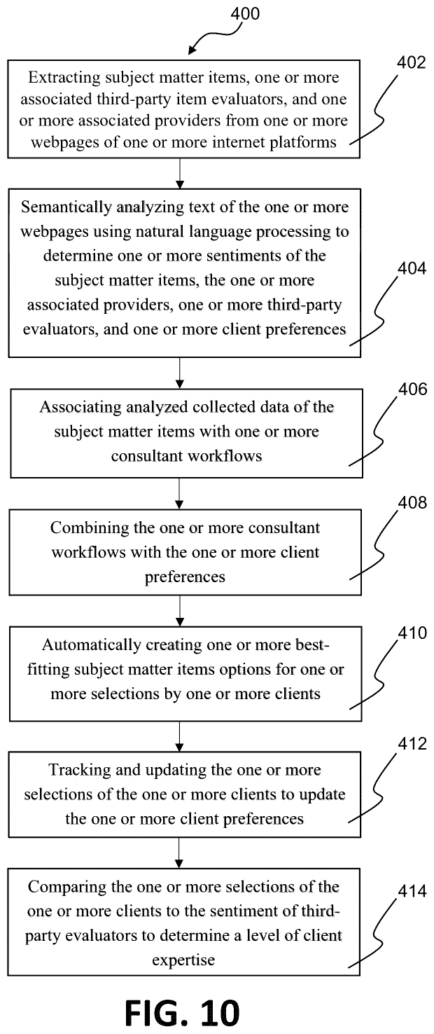

Referring to FIG. 10, with this and other concepts, systems, and methods of the present invention, a method 400 for a consultancy assistance system comprises extracting subject matter items, one or more associated third-party item evaluators, and one or more associated providers from one or more webpages of one or more internet platforms at 402, semantically analyzing the text of the one or more webpages using natural language processing to determine one or more sentiments of the subject matter items, the one or more associated providers, one or more third-party evaluators, and one or more client preferences at 404, associating analyzed collected data of the subject matter items with one or more consultant workflows at 406, combining the one or more consultant workflows with the one or more client preferences at 408, automatically creating one or more best-fitting subject matter items in an option list for one or more selections by one or more clients at 410, tracking and updating the one or more selections of the one or more clients to update the one or more client preferences at 412, and comparing the one or more selections of the one or more clients to the sentiment of third-party evaluators to determine a level of client expertise at 414.

The following examples of use cases as they apply to the online consultancy industry represent how various system actors interact with the system and methods depicted herein:

Use case UC0001:

Header

| Use Case ID | UC0001 |
|---|---|
| Use Case Version | 1.000 |

Body

| Title | Automated Subject Matter Item Provider Access to Consultants | |
|---|---|---|
| Actors | Subject matter item providers, system operators, consultants, clients | |
| Normal Flow | Step 1 | Subject matter item providers sign up by giving the system |
| | | operator information about their subject matter items and |
| | | webpages. |
| | Step 2 | System operator gives the Consultancy Assistance System |
| | | (CAS) the subject matter item provider's related URLs to find, |
| | | extract and analyze the subject matter item provider's |
| | | webpages and related webpages. |
| | Step 3 | Consultants transmit workflow steps based on expertise in a |
| | | subject matter to the CAS. |
| | Step 4 | Consultants transmit subject matter item preferences of the |
| | | clients to the CAS. |
| | Step 5 | System operator uses the CAS to find any matches between the |
| | | subject matter item information associated with a subject |
| | | matter item provider and client preferences gathered by the |
| | | consultant. |
| | Step 6 | If there are one or more matches, the provider is accepted by |
| | | the system operator. |
| | Step 7 | Anonymous aggregate information on the use of subject matter |
| | | item provider's subject matter items on an option list and any |
| | | selection by clients of subject matter items is given to the |
| | | relevant subject matter item provider. |
| | Step 8 | The CAS periodically finds and analyzes relevant provider's |
| | | information to automatically update that information. |
| | Step 9 | New subject matter item providers can be found by the CAS as |
| | | various subject matter items are extracted and analyzed across |
| | | platforms and those new providers invited to submit |
| | | information to the system operator. |

Use case 0001 can be converted to a specific application as shown in use case UC0001a.

Header

| Use Case ID | UC0001a |
|---|---|
| Use Case Version | 1.000 |

Body

| Title | Automated Asset Manager (Provider) Access to Financial Advisors | |
|---|---|---|
| | (Consultants) | |
| Actors | Asset managers (subject matter item providers), finance facilitator (system | |
| | operator), financial advisors (consultants), investor (client) | |
| Example | Step 1 | Asset managers (subject matter item providers) sign up by |
| | | giving the finance facilitator (system operator) information |
| | | about their assets (subject matter items) and webpages. |
| | Step 2 | Finance facilitator (system operator) gives the CAS the asset |
| | | manager's (subject matter item provider's) related URLs to |
| | | analyze the asset manager's (subject matter item provider's) |
| | | webpages and related webpages. |
| | Step 3 | Financial advisors (consultants) transmit workflow steps |
| | | based on expertise in a financial (subject matter) area to the |
| | | CAS. |
| | Step 4 | Financial advisors (consultants) transmit asset (subject matter |
| | | item) preferences of the investors (clients) to the CAS. |
| | Step 5 | Finance facilitator (system operator) uses the CAS to find any |
| | | matches between asset (subject matter item) information |
| | | associated with an asset manager (subject matter item |
| | | provider) and investor (client) preferences gathered by the |
| | | financial advisor (consultant). |
| | Step 6 | If there are one or more matches, the asset manager (subject |
| | | matter item provider) is accepted by the finance facilitator |
| | | (system operator). |
| | Step 7 | Anonymous aggregate information on the use of an asset |
| | | manager's (subject matter item provider's) asset (subject |
| | | matter item) on an option list and any selection by investors |
| | | (clients) of that asset (subject matter item) is given to the |
| | | relevant asset manager (subject matter item provider). |
| | Step 8 | The CAS periodically finds and analyzes relevant asset |
| | | manager's (subject matter item provider's) information to |
| | | automatically update that information. |
| | Step 9 | New asset managers (subject matter item providers) can be |
| | | found by the CAS as various assets (subject matter items) are |
| | | extracted and analyzed across platforms and those new asset |
| | | managers (subject matter item providers) invited to submit |
| | | information to finance facilitator (system operator). |

Use case UC0002:

Header

| Use Case ID | UC0002 |
|---|---|
| Use Case Version | 1.000 |

Body

| Title | Automatic Client Preference Updates | |
|---|---|---|
| Actors | Clients, consultant, system operator | |
| Normal Flow | Step 1 | Consultants are given access to a client's profile information as |
| | | well as to the relevant, subject matter item selections. |
| | Step 2 | The consultant's application is able to cause a client's |
| | | anonymous profile and item selections to be analyzed by |
| | | transferring this information to the CAS system. |
| | Step 3 | The CAS generates a list of subject matter item options based |
| | | on client preferences and the consultant's workflow. The |
| | | options are ordered based on AI-generated probabilities of |
| | | meeting client goals. This option list is included in the client |
| | | plan and presented to the client by the consultant. |
| | Step 4 | The client preferences are updated in part based on their |
| | | selections from these lists of options. |
| | Step 5 | The updated client preferences are available to the client- |
| | | associated consultant. |

Use case 0002 can be converted to a specific application as shown in use case UC0002a.

Header

| Use Case ID | UC0002a |
|---|---|
| Use Case Version | 1.000 |

Body

| Title | Automatic Investor (Client) Preference Updates | |
|---|---|---|
| Actors | Investors (clients), financial advisors (consultants), finance facilitator | |
| | (system operator) | |
| Normal Flow | Step 1 | Financial advisors (consultants) are given access to an |
| | | investor's (client's) profile information as well as to the |
| | | relevant, asset (subject matter item) selections made by the |
| | | investor (client). |
| | Step 2 | The financial advisor's (consultant's) application is able to |
| | | cause the investor's (client's) profile and asset (subject matter |
| | | item) selections to be analyzed by transferring this information |
| | | to the CAS system. |
| | Step 3 | The CAS generates a list of asset (subject matter item) options |
| | | based on investor (client) preferences and the financial |
| | | advisor's (consultant's) workflow. The options are ordered |
| | | based on AI-generated probabilities of meeting investor |
| | | (client) goals. This option list is included in the investor |
| | | (client) plan and presented to the investor (client) by the |
| | | financial advisor (consultant). |
| | Step 4 | The client preferences are updated in part based on their |
| | | selections from these lists of options. |
| | Step 5 | The updated investor (client) preferences are available to the |
| | | client-associated financial advisor (consultant). |

Use case UC0003:

Header

| Use Case ID | UC0003 |
|---|---|
| Use Case Version | 1.000 |

Body

| Title | Automatic Consultant Workflow Step Option Determination | |
|---|---|---|
| Actors | Consultants, clients | |
| Normal Flow | Step 1 | Consultants typically follow workflows to ensure that the |
| | | service provided is uniform. Workflows contain multiple work |
| | | steps, each of which can contain plain text, subject matter item |
| | | options, plans, or advisory notices. Subject matter items can be |
| | | selected at each step/plan/advisory notice. |
| | Step 2 | Using the client's preferences, the CAS can ensure that only |
| | | preferred options are presented to the client at each specific |
| | | workflow step/plan/advisory notice. |
| | Step 3 | The subject matter item selected by the client at each |
| | | step/plan/advisory notice can be tracked and used by the CAS |
| | | to update a client's subject matter item preferences. |
| | Step 4 | The CAS can compare the client selection with the sentiment |
| | | from third-party evaluations to determine client expertise. |
| | Step 5 | Changing the subject matter items within each workflow step |
| | | automatically causes the client preferences of unused |
| | | workflow steps to be reevaluated for the current client. |

Use case 0003 can be converted to a specific application as shown in use case UC0003a.

Header

| Use Case ID | UC0003a |
|---|---|
| Use Case Version | 1.000 |

Body

| Title | Automatic Financial Advisor (Consultant) Workflow Step Option | |
|---|---|---|
| | Determination | |
| Actors | Financial advisors (consultants), investors (clients) | |
| Normal Flow | Step 1 | Financial advisors (consultants) typically follow workflows to |
| | | ensure that the service provided is uniform. Workflows contain |
| | | multiple work steps, each of which can contain plain text, |
| | | asset (subject matter item) options, plans, or advisory notices. |
| | | Assets (subject matter items) can be selected at each |
| | | step/plan/advisory notice. |
| | Step 2 | Using the client's preferences, the CAS can ensure that only |
| | | preferred options are presented to the investor (client) at the |
| | | specific workflow step/plan/advisory notice. |
| | Step 3 | The asset (subject matter item) selected by the investor |
| | | (client) at each step/plan/advisory notice can be tracked and |
| | | used by CAS to update an investor's (client's) asset (subject |
| | | matter item) preferences. |
| | Step 4 | The CAS can compare the investor (client) selection with the |
| | | sentiment from third-party evaluations to determine investor |
| | | (client) expertise. The CAS can combine the (client) selection |
| | | with reviewer sentiment to determine the effects of reviews on |
| | | an investor's (client's) asset (subject matter item) selection. |
| | Step 5 | Changing the assets (subject matter items) within a workflow |
| | | step automatically causes the investor (client) preferences of |
| | | unused workflow steps to be reevaluated for the current |
| | | investor (client). |

In various embodiments, the one or more webpages include expert analyses, third-party reviews, social media posts, or newsfeed webpages.

In various embodiments, the natural language processing includes processing by a BERT model.

In various embodiments, the one or more sentiments are determined from keywords or key phrases using the natural language processing.

In various embodiments, the one or more sentiments include strongly negative data, negative data, neutral data, positive data, or strongly positive data.

In various embodiments, the one or more client preferences include one or more anonymous client preferences.

In various embodiments, the one or more associated providers interact with a system operator to confirm identified goods or services.

In various embodiments, the one or more consultant workflows contain one or more workflow steps or one or more conditional statements, and the one or more workflow steps contain descriptions, keywords, plans, or advisor notices.

In various embodiments, the one or more associated providers include one or more associated asset managers, the one or more consultant workflows include one or more financial advisor workflows, and the subject matter items include financial assets.

In various embodiments, the subject matter items include information on goods or services.

Various devices or computing systems can be included and adapted to process and carry out the aspects, computations, and algorithmic processing of the software systems and methods of the present invention. Computing systems, devices, or appliances of the present invention may include a computer system, which may include one or more microprocessors, one or more processing cores, and/or one or more circuits, such as an application-specific integrated circuit (ASIC), field-programmable gate arrays (FPGAs), graphics processing units (GPU), general purpose graphics processing units (GPGPU), etc. Any such device or computing system is defined as a processing element herein. A server processing system for use by or connected with the systems of the present invention may include a processor, which may include one or more processing elements. Further, the devices can include a network interface or a bus system in cases where the processing elements are within the same chip. The network interface is configured to enable communication with the internet, communication networks, other devices and systems, and servers, using a wired and/or wireless connection.

The devices or computing systems may include memory, such as non-transitive, which may include one or more non-volatile storage devices and/or one or more volatile storage devices (e.g., random access memory (RAM)). In instances where the devices include a microprocessor, computer-readable program code may be stored in a computer-readable medium or memory, such as but not limited to magnetic media (e.g., a hard disk), optical media (e.g., an OVO), memory devices (e.g., random access memory, flash memory), etc. The computer program or software code can be stored on a tangible, or non-transitive, machine-readable medium or memory. In some embodiments, computer-readable program code is configured such that when executed by a processing element, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The devices, appliances, or computing devices may include an input device. The input device is configured to receive an input from either a user (e.g., admin, user, etc.) or a hardware or software component as disclosed herein in connection with the various user interface or automatic data inputs. Examples of an input device include data ports, keyboards, a mouse, a microphone, scanners, sensors, touch screens, game controllers, and software enabling interaction with a touch screen, etc. The devices can also include an output device. Examples of output devices include monitors, televisions, mobile device screens, tablet screens, speakers, remote screens, screen less 3D displays, data ports, HUDs, etc. An output device can be configured to display images, media files, text, or video, or play audio to a user through speaker output.

The term communication network includes one or more networks such as a data network, wireless network, a telephony network, or any combination thereof. It is contemplated that the data network may be any local area network (LAN), metropolitan area network (MAN), wide area network (WAN), the internet, cloud computing platform, or any other suitable packet-switched network, such as a commercially owned, proprietary packet-switched network, e.g., a proprietary cable or fiber-optic network. In addition, the wireless network may be, for example, a cellular network and may employ various technologies including global system for mobile communications (GSM), internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WIFI), satellite, mobile ad-hoc network (MANET), and the like.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

While various embodiments have been described above, it should be understood that they have been presented by way of example only, and not limitation. Thus, the breadth and scope of the present disclosure should not be limited by any on the above-described embodiments or examples. Moreover, any combination of the above-described elements in all possible variations thereof is encompassed by the disclosure unless otherwise indicated herein or otherwise clearly contradicted by context.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

While the present invention has been described in connection with various aspects and examples, it will be understood that the present invention is capable of further modifications. This application is intended to cover any variations, uses or adaptation of the invention following, in general, the principles of the invention, and including such departures from the present disclosure as come within the known and customary practice within the art to which the invention pertains.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112 (f) are not to be invoked unless the specific terms “means for” or “step for” are recited in a claim.

1. A software method of a consultancy assistance system, comprising:
extracting subject matter items from one or more webpages of one or more internet platforms;
semantically processing and analyzing text data or image data of the one or more webpages using natural language processing to determine one or more sentiments of one or more third-party evaluators for the subject matter items based on analysis from the one or more third-party evaluators considering one or more client preferences and analysis of anonymous aggregate client data;
associating analyzed collected data of the subject matter items with one or more consultant workflows;
combining the one or more consultant workflows with the one or more client preferences;
automatically processing and creating one or more best-fitting subject matter items options for one or more selections by one or more clients after the determination of the one or more sentiments of the one or more third-party evaluators is made;
tracking and updating the one or more selections of the one or more clients to update the one or more client preferences; and
comparing the one or more selections of the one or more clients to the one or more sentiments of the third-party evaluators to determine a level of client expertise after the automatic processing and creating of the one or more best-fitting subject matter items options, wherein the level of client expertise is calculated based on a percentage comparing how close the one or more client preferences are to the one or more sentiments of the one or more third-party evaluators, and wherein the greater the percentage is calculated that the one or more client preferences match the one or more sentiments of the one or more third-party evaluators the greater the level of client expertise. Page

2. The method of claim 1, wherein the one or more webpages include expert analyses, third-party reviews, social media posts, or newsfeed webpages.

3. The method of claim 1, wherein the natural language processing includes processing by a Bidirectional Encoder Representations from Transformers (BERT) model.

4. The method of claim 1, wherein the one or more sentiments are determined from keywords or key phrases using the natural language processing.

5. The method of claim 1, wherein the one or more sentiments include strongly negative data, negative data, neutral data, positive data, or strongly positive data.

6. (canceled)

7. The method of claim 1, wherein the determination of the one or more sentiments is further based on one or more associated providers, and wherein the one or more associated providers interact with a system operator to confirm identified goods or services.

8. The method of claim 1, wherein the one or more consultant workflows contain one or more workflow steps or one or more conditional statements, and the one or more workflow steps contain descriptions, keywords, plans, or advisor notices.

9. The method of claim 7, wherein the one or more associated providers include one or more associated asset managers, the one or more consultant workflows include one or more financial advisor workflows, and the subject matter items include financial assets.

10. (canceled)

11. A software consultancy assistance system, comprising:
a memory; and
a processor operatively coupled with the memory, wherein the processor is configured to execute program code to:
extract subject matter items from one or more webpages of one or more internet platforms;
semantically process and analyze text data or image data of the one or more webpages using natural language processing to determine one or more sentiments of one or more third-party evaluators for the subject matter items based on analysis from the one or more third-party evaluators considering one or more client preferences and analysis of anonymous aggregate client data;
associate analyzed collected data of the subject matter items with one or more consultant workflows;
combine the one or more consultant workflows with the one or more client preferences;
automatically process and create one or more best-fitting subject matter items options for one or more selections by one or more clients after the determination of the one or more sentiments of the one or more third-party evaluators is made;
track and update the one or more selections of the one or more clients to update the one or more client preferences; and
compare the one or more selections of the one or more clients to the one or more sentiments of the third-party evaluators to determine a level of client expertise after the automatic processing and creating of the one or more best-fitting subject matter items options, wherein the level of client expertise is calculated based on a percentage comparing how close the one or more client preferences are to the one or more sentiments of the one or more third-party evaluators, and wherein the greater the percentage is calculated that the one or more client preferences match the one or more sentiments of the one or more third-party evaluators the greater the level of client expertise.

12. The system of claim 11, wherein the one or more webpages include expert analyses, third-party reviews, social media posts, or newsfeed webpages.

13. The system of claim 11, wherein the natural language processing includes processing by a Bidirectional Encoder Representations from Transformers (BERT) model.

14. The system of claim 11, wherein the one or more sentiments are determined from keywords or key phrases using the natural language processing.

15. The system of claim 11, wherein the one or more sentiments include strongly negative data, negative data, neutral data, positive data, or strongly positive data.

16. (canceled)

17. The system of claim 11, wherein the determination of the one or more sentiments is further based on one or more associated providers, and wherein the one or more associated providers interact with a system operator to confirm identified goods or services.

18. The system of claim 11, wherein the one or more consultant workflows contain one or more workflow steps or one or more conditional statements, and the one or more workflow steps contain descriptions, keywords, plans, or advisor notices.

19. The system of claim 17, wherein the one or more associated providers include one or more associated asset managers, the one or more consultant workflows include one or more financial advisor workflows, and the subject matter items include financial assets.

20. (canceled)

21. A software method of a consultancy assistance system, comprising:
extracting subject matter items from one or more webpages of one or more internet platforms;
extracting text data or image data from the one or more webpages that comprises third-party evaluations of the subject matter items;
accessing one or more client preferences for one or more clients related to the subject matter items or other subject matter items;
semantically processing and analyzing, based on the one or more client preferences and anonymous aggregate client data, the text data or image data from the one or more webpages using natural language processing to determine one or more sentiments of the third-party evaluations with regard to the subject matter items;
associating analyzed collected data of the subject matter items with one or more consultant workflows based on matching the analyzed collected data of the subject matter items with the one or more client preferences using the one or more consultant workflows;
combining the one or more consultant workflows with the one or more client preferences;
based on the combination of the one or more consultant workflows and the one or more client preferences, automatically processing and creating one or more best-fitting subject matter item options for selection by the one or more clients after the determination of the one or more sentiments of the one or more third-party evaluations is made;
presenting the best-fitting subject matter item options to the one or more clients for selection;
receiving information identifying one or more selections of the best-fitting subject matter item options by the one or more clients;
iteratively performing the following operations in response to receipt of each selection of the one or more selections:
identifying online platform-independent text associated with the selection;
semantically analyzing the online platform-independent text associated with the selection;
updating the one or more client preferences based on the selection and the semantic analysis of the online platform-independent text associated with the selection; and
determining a level of client expertise based on calculating a percentage comparing how close the one or more client preferences are to the one or more sentiments of the one or more third-party evaluations, and wherein the greater the percentage is calculated that the one or more client preferences match the one or more sentiments of the one or more third-party evaluations the greater the level of client expertise.

22. The method of claim 21, wherein the automatically processing and creating the one or more best-fitting subject matter items options comprises matching the subject matter items to keywords for a step of the one or more consultant workflows and comparing the subject matter items matched with the keywords to the one or more client preferences.

23. The method of claim 22, wherein the one or more best-fitting subject matter items options are included in a list ordered based on one or more probabilities of meeting client goals from a highest probability to a lowest probability.

24. The method of claim 23, wherein the one or more probabilities of meeting client goals are determined by generative artificial intelligence.
